(19) United States
(12) Patent Application Publication
(10) Pub. No.: US 2005/0226530 A1
(43) Pub. Date: Oct. 13, 2005

(54) Image processing program, image processing method, image processing apparatus and storage medium

(76) Inventor: Hajime Murayama, Sagamihara-shi (JP)

Correspondence Address: STRAUB & POKOTYLO, 620 TINTON AVENUE, BLDG. B, 2ND FLOOR, TINTON FALLS, NJ, 07724, US

(21) Appl. No.: 11/099,275

(22) Filed: Apr. 5, 2005

(30) Foreign Application Priority Data
Apr. 8, 2004 (JP) 2004-114103

(51) Int. Cl. G06K 9/36; G06K 9/03; G06K 9/68

(52) U.S. Cl. 382/276; 382/309; 382/226

(57) ABSTRACT

There is provided a method which is executed in an image processing apparatus includes, determining an image displayed in an image display area in accordance with a first history icon as a processing target image, selecting image processing, executing the selected image processing to the processing target image, displaying a processing result image, storing a content of the executed image processing and the processing result image, generating a second history icon representing the executed image processing, adding and displaying the second history icon successively after the first history icon, determining the displayed image as a new processing target image, and repeatedly executing selection of image processing to addition and display of a history icon, selecting a third history icon, displaying a processing result image, determining the displayed image as a new processing target image, and repeatedly executing selection of image processing to addition and display of a history icon.

### CROSS-REFERENCE TO RELATED APPLICATIONS

This application is based upon and claims the benefit of priority from prior Japanese Patent Application No. 2004-114103, filed Apr. 8, 2004, the entire contents of which are incorporated herein by reference.

### BACKGROUND OF THE INVENTION

1. Field of the Invention

The present invention relates to a technique of simply and easily executing a reattempt of information processing including an image.

2. Description of the Related Art

There is a case where arbitrary information processing should be reattempted and executed in midstream after the information processing is continuously executed. If a reattempt can be easily operated in such a case, it is very convenient.

As a technique which meets this need, there is proposed a technique which can return to a processing state at an arbitrary point in the past by canceling executed processing or which can make a reattempt in a data processing state at an arbitrary point in time by re-executing a once-canceled update command (Jpn. Pat. Appln. KOKAI Publication No. 2000-76244).

### BRIEF SUMMARY OF THE INVENTION

A first aspect of the present invention is directed to an image processing program executed in an image processing apparatus which comprises: an information memory which stores information including an image; an image processing portion which executes a plurality of sets of processing to an image; and a display having an image display area in which an image is displayed and a history display area in which an image processing history is displayed in the form of a tree of history icons representing image processing, the program causing the image processing apparatus to execute:
an image processing selection step of determining an image displayed in the image display area in accordance with a first history icon selected in the history display area as a processing target image, and selecting image processing which is performed to the processing target image; an image processing step of executing the image processing selected at the image processing step with respect to the processing target image; an image display step of displaying a processing result image generated as a processing result of the image processing executed at the image processing step instead of the processing target image in the image display area; a history storage step of storing the processing result image and processing information indicative of a content of the image processing executed at the image processing step in the information memory; a history icon generation step of generating a second history icon representing the image processing executed at the image processing step; a history icon display step of setting the second history icon in a selection state successively after the first history icon and adding and displaying the second history icon in the history display area; a first repeat step of determining the image displayed in the image display area at the image display step as a new processing target image and repeatedly executing the image processing selection step to the history icon display step; a history icon selection step of selecting a third history icon displayed in the history display area; a second image display step of displaying a processing result image of image processing represented by the third history icon selected at the history icon selection step instead of the image displayed in the image display area; and a second repeat step of determining the image displayed in the image display area at the second image display step as a new processing target image and repeatedly executing the image processing selection step to the history icon display step.

A second aspect of the present invention is directed to an image processing method executed in an image processing apparatus which comprises: an information memory which stores information including an image; an image processing portion which executes a plurality of sets of processing with respect to an image; and a display having an image display area in which an image is displayed and a history display area in which an image processing history is displayed in the form of a tree of history icons representing image processing, the method includes: (A1) determining an image displayed in the image display area in accordance with a first history icon selected in the history display area as a processing target image, and selecting image processing which is performed with respect to the processing target image; (A2) executing the image processing selected at (A1) with respect to the processing target image; (A3) displaying in the image display area a processing result image generated as a processing result of the image processing executed at (A2) in place of the processing target image; (A4) storing in the information memory the processing result image and processing information indicative of a content of the image processing executed at (A2); (A5) generating a second history icon representing the image processing executed at (A2); (A6) adding and displaying the second history icon successively after the first history icon in the history display area; (A7) determining the image displayed in the image display area at (A3) as a new processing target image, and repeatedly executing (A1) to (A6); (A8) selecting a third history icon displayed in the history display area; (A9) displaying a processing result image of image processing represented by the third history icon selected at (A8) in place of the image displayed in the image display area; and (A10) determining the image displayed in the image display area at (A9) as a new processing target image, and repeatedly executing (A1) to (A6).

A third aspect of the present invention is directed to an image processing apparatus includes:
an information memory which stores information including an image; an image processing portion which executes a plurality of sets of processing with respect to an image; a display having an image display area in which an image is displayed and a history display area in which an image processing history is displayed in the form of a tree of history icons; an image processing selection portion which determines an image displayed in the image display area in accordance with a first history icon selected in the history display area as a processing target image, and selects image processing which is performed with respect to the processing target image; an image processing portion which executes the image processing selected by the image processing selection portion with respect to the processing target image; an image display portion which displays in the image display area a processing result image generated as a processing result of the image processing executed by the image processing portion in place of the processing target image; a history storage portion which stores the processing result image and processing information indicative of a content of the image processing executed by the image processing portion in the information memory; a history icon generation portion which generates a second history icon representing the image processing executed by the image processing portion; a history icon display portion which sets the second history icon in a selection state successively after the first history icon, and adds and displays the second history icon in the history display area; a first repeat portion which determines the image displayed in the image display area by the image display portion as a new processing target, and repeatedly executes operations of the image processing selection portion to the history icon display portion; a history icon selection portion which selects a third history icon displayed in the history display area; a second image display portion which displays a processing result image of image processing represented by the third history icon selected by the history icon selection portion in place of an image displayed in the image display area; and a second repeat portion which determines the image displayed in the image display area by the second image display portion as a new processing target, and repeatedly executes operations of the image processing selection portion to the history icon display portion.

A fourth aspect of the present invention is directed to a storage medium having a program recorded therein, the program being executed in an image processing apparatus comprising: an information memory which stores information including an image; an image processing portion which executes a plurality of sets of processing with respect to an image; and a display having an image display area in which an image is displayed and a history display area in which an image processing history is displayed in the form of a tree of history icons representing image processing,
the storage medium having the program recorded therein, the program causing a computer to execute: an image processing selection step of determining an image displayed in the image display area in accordance with a first history icon selected in the history display area as a processing target image, and selecting image processing which is performed with respect to the processing target image; an image processing step of executing the image processing selected at the image processing selection step with respect to the processing target image; an image display step of displaying in the image display area a processing result image generated as a processing result of the image processing executed at the image processing step in place of the processing target image; a history storage step of storing in the information memory the processing result image and processing information indicative of a content of the image processing executed at the image processing step; a history icon generation step of generating a second history icon representing the image processing executed at the image processing step; a history icon display step of setting the second history icon in a selection state successively after the first history icon, and adding and displaying the second history icon in the history display area; a first repeat step of determining the image displayed in the image display area at the image display step as a new processing target image and repeatedly executing the image processing selection step to the history icon display step; a history icon selection step of selecting a third history icon displayed in the history display area; a second image display step of displaying a processing result image of image processing represented by the third history icon selected at the history icon selection step in place of an image displayed in the image display area; and a second repeat step of determining the image displayed in the image display area at the second image display step as a new processing target image and repeatedly executing the image processing selection step to the history icon display step.

Advantages of the invention will be set forth in the description which follows, and in part will be obvious from the description, or may be learned by practice of the invention. Advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a view showing a configuration of an image history screen;

FIG. 2 is a view showing an image edition list;

FIG. 3 is a view illustrating a method of adding and displaying a history tree;

FIG. 4 is a view illustrating another method of adding and display a history tree;

FIG. 5 is a view illustrating a history selection processing method;

FIG. 6 is a view showing history deletion processing;

FIG. 7A is a view illustrating deletion processing;

FIG. 7B is a view illustrating the deletion processing;

FIG. 7C is a view illustrating the deletion processing;

FIG. 8A is a view illustrating the deletion processing;

FIG. 8B is a view illustrating the deletion processing;

FIG. 8C is a view illustrating the deletion processing;

FIG. 9 is a view illustrating comparison processing for a history image;

FIG. 10 is a view illustrating save processing for a history image;

FIG. 11 is a view illustrating history process saving processing for a history image;

FIG. 12 is a view illustrating history process read processing;

FIG. 13 is a view illustrating the history process read processing;

FIG. 14A is a view illustrating history process coupling processing;

FIG. 14B is a view illustrating the history process coupling processing;

FIG. 15 is a view showing a configuration of an image processing apparatus;

FIG. 16 is a flowchart showing a general procedure of image history processing;

FIG. 17 is a flowchart showing a history generation processing procedure;

FIG. 18 is a flowchart showing a history deletion processing procedure;

FIG. 19 is a flowchart showing the history deletion processing procedure;

FIG. 20 is a flowchart showing a history image comparison processing procedure;

FIG. 21 is a flowchart showing a history image save processing procedure;

FIG. 22 is a flowchart showing a history process save processing procedure;

FIG. 23 is a flowchart showing a history process read processing procedure;

FIG. 24 is a flowchart showing a history process read processing procedure; and

FIG. 25 is a flowchart showing history processing coupling processing.

### DETAILED DESCRIPTION OF THE INVENTION

In an image processing method according to an embodiment of the present invention, a user executes management and reattempt operations of an image history based on an image history screen displayed in a display portion of an information processing apparatus.

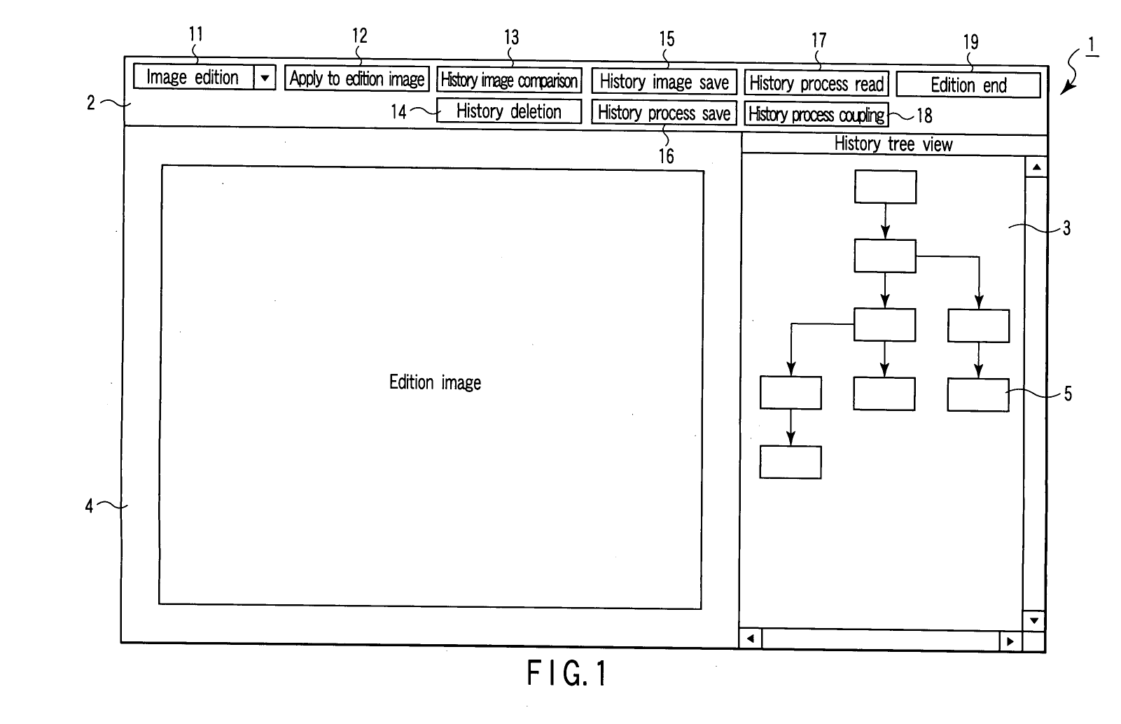

FIG. 1 is a view showing a configuration of an image history screen.

The image history screen 1 comprises a tool bar area 2, a history tree display area 3 and an edition image display area 4. Various kinds of buttons which are used to perform operations concerning image history display are provided in the tool bar area 2. In the history tree display area 3, a history of image processing operations performed by a user is displayed in a tree format including thumbnail images 5. Images subjected to edition processing are displayed in the edition image display area 4.

In the tool bar area 2 are provided an image edition list button 11, an apply-to-edition-image button 12, a history image comparison button 13, a history deletion button 14, a history image save button 15, a history process save button 16, a history process read button 17, a history process coupling button 18, and an edition end button 19.

When the image edition list button 11 is operated, an image processing menu is presented. When the apply-to-edition-image button 12 is operated, a processing content selected by a user is applied to an image. When the history image comparison button 13 is operated, a plurality of images to be compared are displayed in the edition image display area 4. When the history deletion button 14 is operated, a selected history thumbnail image 5 is deleted from the history tree display area 3.

When the history image save button 15 is operated, an actual image corresponding to the selected history thumbnail image 5 is saved. When the history process save button 16 is operated, a history of processes applied to an original image is saved. When the history process read button 17 is operated, a saved history process is added to the history tree. When the history process coupling button 18 is operated, processes which are continuous in the history tree are coupled with each other.

In the history tree display area 3, a history of image processing operations performed by a user is displayed in a tree format including history thumbnail images 5. In the example shown in FIG. 1, how an original image A is changed to images B, C and D by performing a series of image processing is shown by viewing the history thumbnail images 5. Further, there is also displayed that the image processing is not a single route and any other route of a history process also exists. FIG. 1 shows that there are a history process processed in the order of A, B, E and F as well as a history process processed in the order of A, B, C, G and H.

An outline of an image history processing method will now be described with reference to FIG. 1.

When a user displays the image history screen 1, the operation buttons 11 to 19 are displayed in the tool bar area 2. Thus, when the user selects an arbitrary image stored in an information processing apparatus, this image is displayed in the edition image display area 4. In addition to this, a history tree including the history thumbnail images 5 of the selected image is displayed in the history tree display area 3.

In this example, an image to be selected may be an image input from the outside, or may be an image input from an imaging apparatus. With the above-described preparation, each function concerning the image history processing can be executed.

An image edition method will be first described.

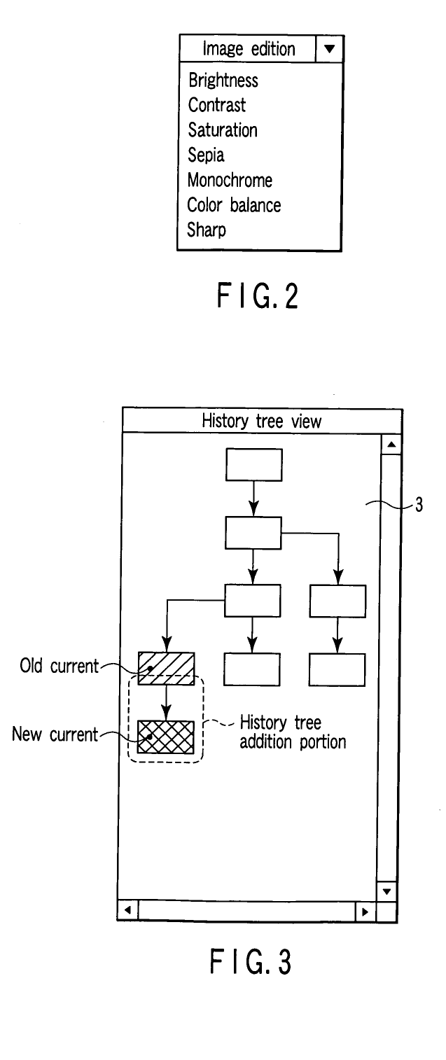

When a user operates the image edition button 11, an image edition list shown in FIG. 2 is displayed in a pulldown menu. When the user selects desired processing from this image edition list, a content of this processing (not shown) is displayed. For example, when “brightness” is selected, a plurality of numbers from −10 to +10 are displayed. Then, when the user selects “+5” as the brightness and operates the apply-to-edition-image button 12, processing having the selected content is applied to an image displayed in the edition image display area 4, and the image is updated to an image obtained as a result of this processing.

Moreover, this processing process is added and displayed as a history tree in the history tree display portion 3.

FIG. 3 is a view illustrating a method of adding and displaying a history tree. When image processing selected in the image edition list is performed with respect to an image provided at an end portion of the history tree, a new history thumbnail image 5 after processing is added and displayed in the history tree ahead of a thumbnail image indicating a current state (a present state) of the history tree.

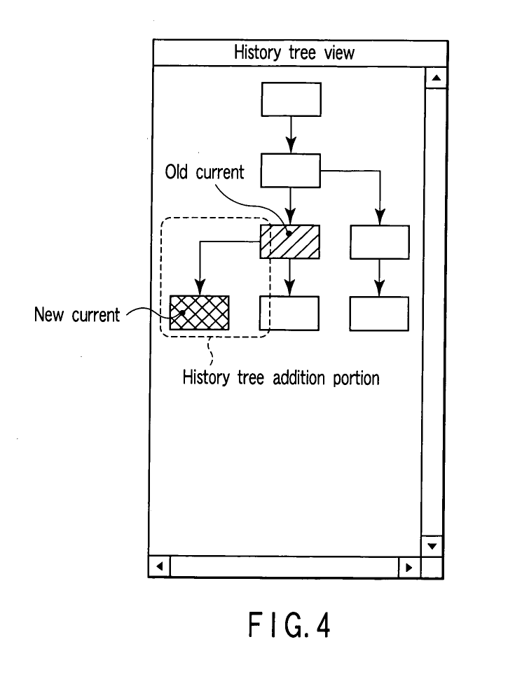

FIG. 4 is a view illustrating another method of adding and displaying a history tree. When image processing selected in the image edition list is performed with respect to an image provided at an intermediate portion of the history tree, a new route is created separately from existing routes of the history thumbnail images 5 with a position of a history thumbnail image 5 which is an edition target being determined as a diverging point. Additionally, a new history thumbnail image 5 is added at the end of the created history tree.

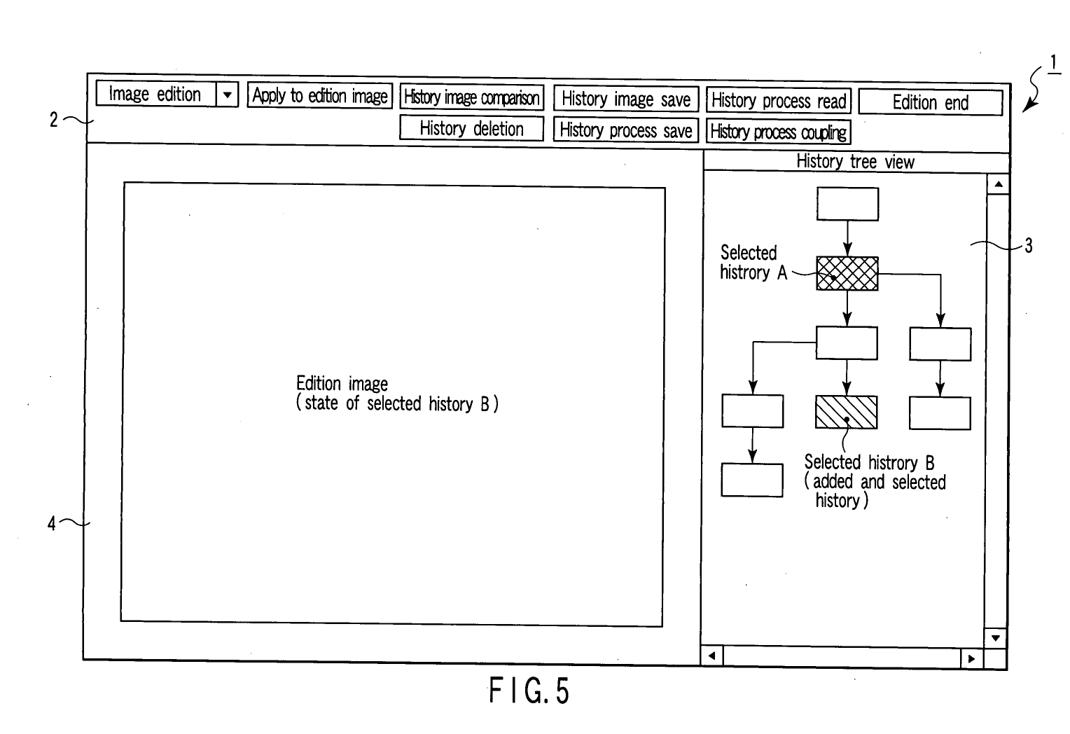

History selection processing will now be described with reference to FIG. 5.

When a user clicks a history thumbnail image 5 displayed in the history tree display area 3, display of the selected history thumbnail image 5 is changed to a selection state, and an image corresponding to the selected history thumbnail image 5 is displayed in the edition image display portion 4.

Further, when another history thumbnail image 5 is selected while pressing a specific key in a keyboard, e.g., a shift key in a state where the selected history thumbnail image 5 exists, the selected history is added, the plurality of histories are selected, and an image corresponding to the newly selected history thumbnail image 5 is displayed in the edition image display portion 4. In this manner, an image corresponding to the selected history thumbnail image 5 is displayed in the edition image display portion 4 every time the history thumbnail image 5 is selected.

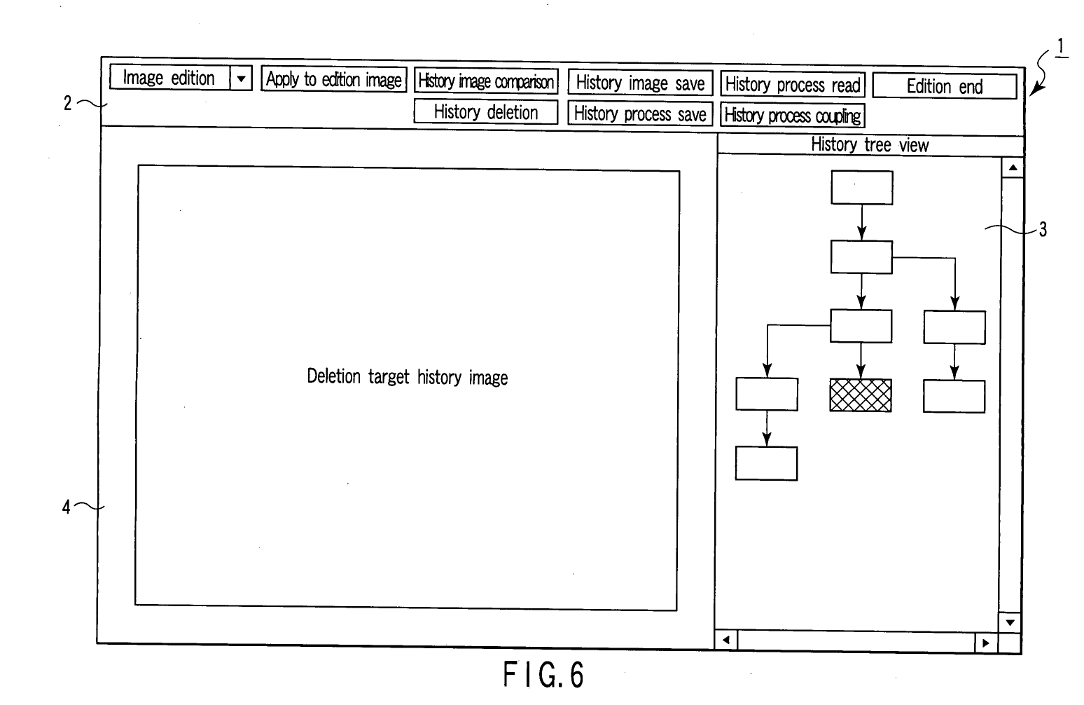

History deletion processing will now be described with reference to FIG. 6.

When a user selects one or more history thumbnail images 5 as deletion targets from history thumbnail images 5 displayed in the history tree, display of the history thumbnail image 5 enters the selection state just like the above-described selection processing. Furthermore, an image corresponding to the selected history thumbnail image 5 is displayed in the edition image display portion 4. When the user presses the history deletion button 14 in this state, a menu (not shown) which is used to select either a “selected history only” mode or a “selected history and subsequent histories” mode is displayed. When the user selects one mode, deletion processing corresponding to the selected mode is executed.

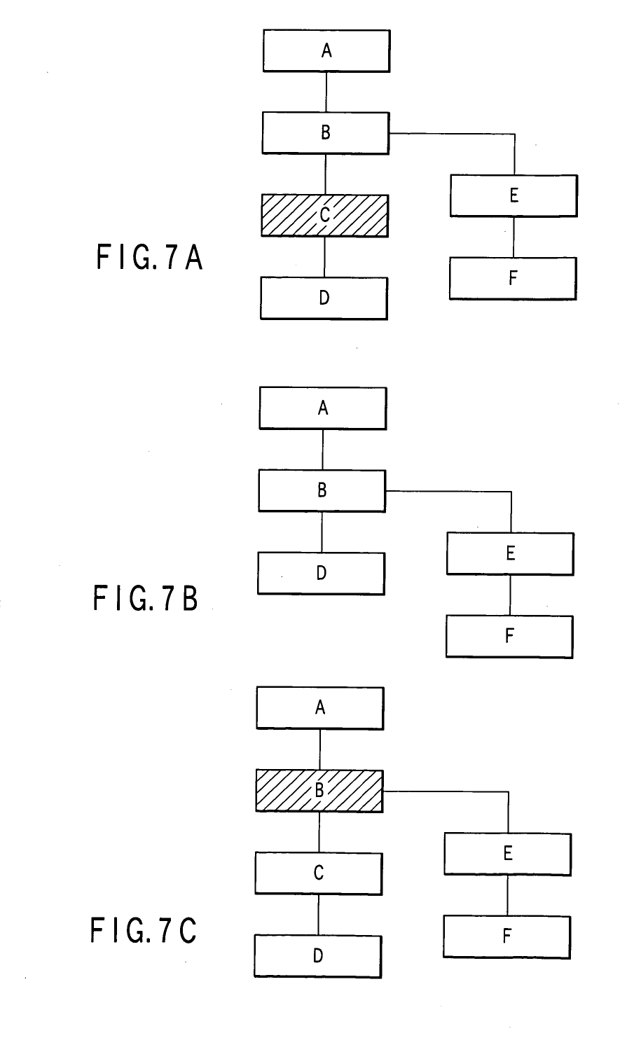

FIG. 7 are views illustrating deletion processing in the “selected history only” mode.

FIG. 7A shows a state in which a history process C is selected as a history thumbnail image 5. When history deletion processing is executed, as shown in FIG. 7B, image data and an image processing content concerning the history process C as the history thumbnail image 5 are deleted. As shown in FIG. 7C, when a history process B as a history thumbnail image 5 placed at a diverging point is selected, deletion is impossible and hence the processing is not executed.

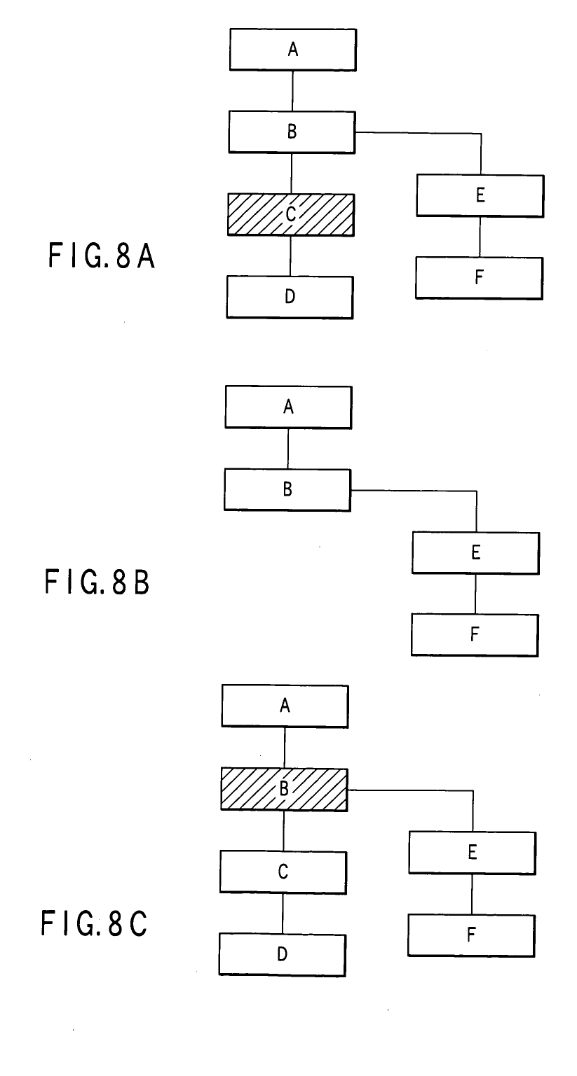

FIG. 8 are views illustrating deletion processing in the “selected history and subsequent histories” mode.

FIG. 8A shows a state in which a history process C is selected as a history thumbnail image 5. When the history deletion processing is executed, as shown in FIG. 8B, image data and image processing contents concerning the history processes C and D as the history thumbnail images 5 are deleted. As shown in FIG. 8C, when a history process B as a history thumbnail image 5 placed at a diverging point is selected, deletion is impossible and hence the processing is not executed.

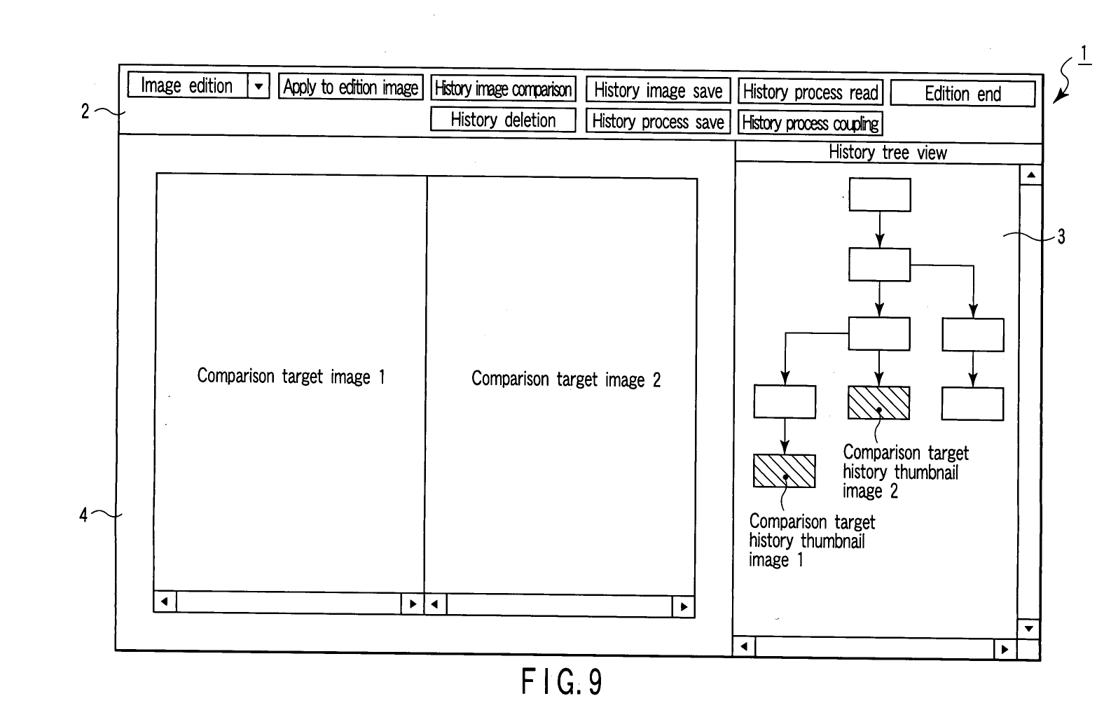

History image comparison processing will now be described with reference to FIG. 9.

When a user selects a plurality of history thumbnail images 5 which should be displayed for comparison from history thumbnail images 5 displayed in a history tree, display of the history thumbnail images 5 enters a selection state just like the above-described selection processing, and images corresponding to the selected history thumbnail images 5 are displayed in the edition image display portion 4. Then, when the user presses the history image comparison button 13, the plurality of selected images are displayed in parallel in the edition image display area 4.

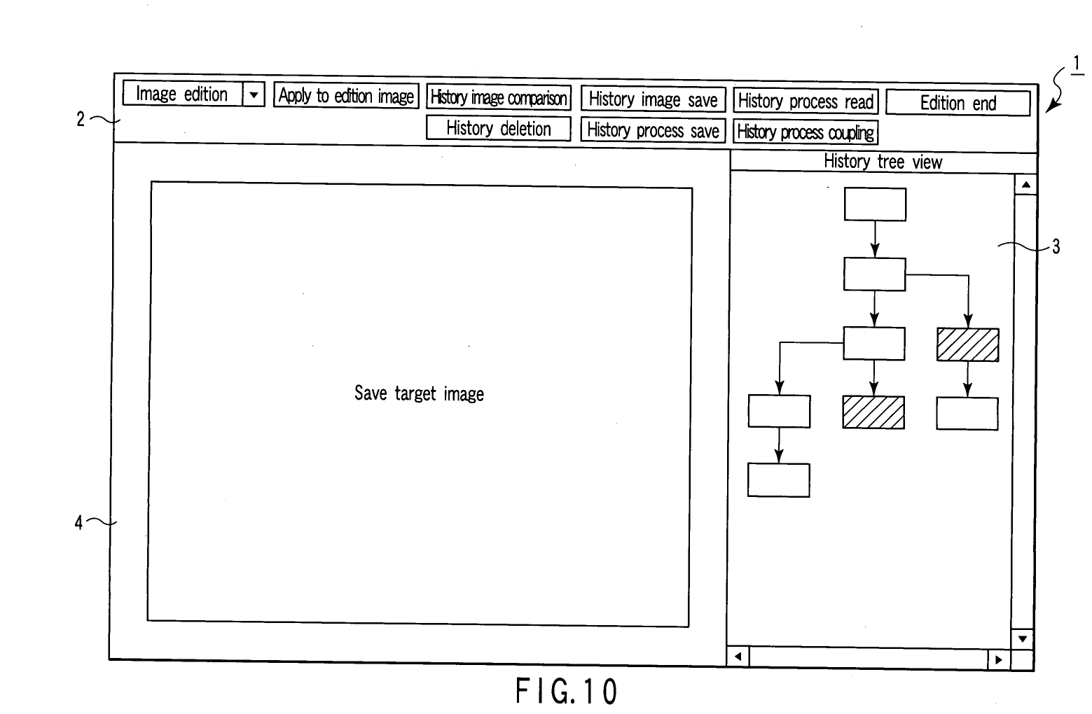

History image save processing will now be described with reference to FIG. 10.

When a user selects a plurality of history thumbnail images 5 which should be saved from history thumbnail images 5 displayed in a history tree, display of the history thumbnail images 5 is changed to a selection state just like the above-described selection processing, and images corresponding to the selected history thumbnail images 5 are displayed in parallel in the edition image display portion 4. At this moment, a state of a save target history is also displayed together with the images.

Then, when the user presses the history image save button 15, a box (not shown) which is used to set a folder in which images are saved, a file name under which images are saved, an image format in which images are saved and others is displayed. When the data is set in this box, the save processing is performed in an actual image size. This save processing is executed with respect to all the selected history thumbnail images 5.

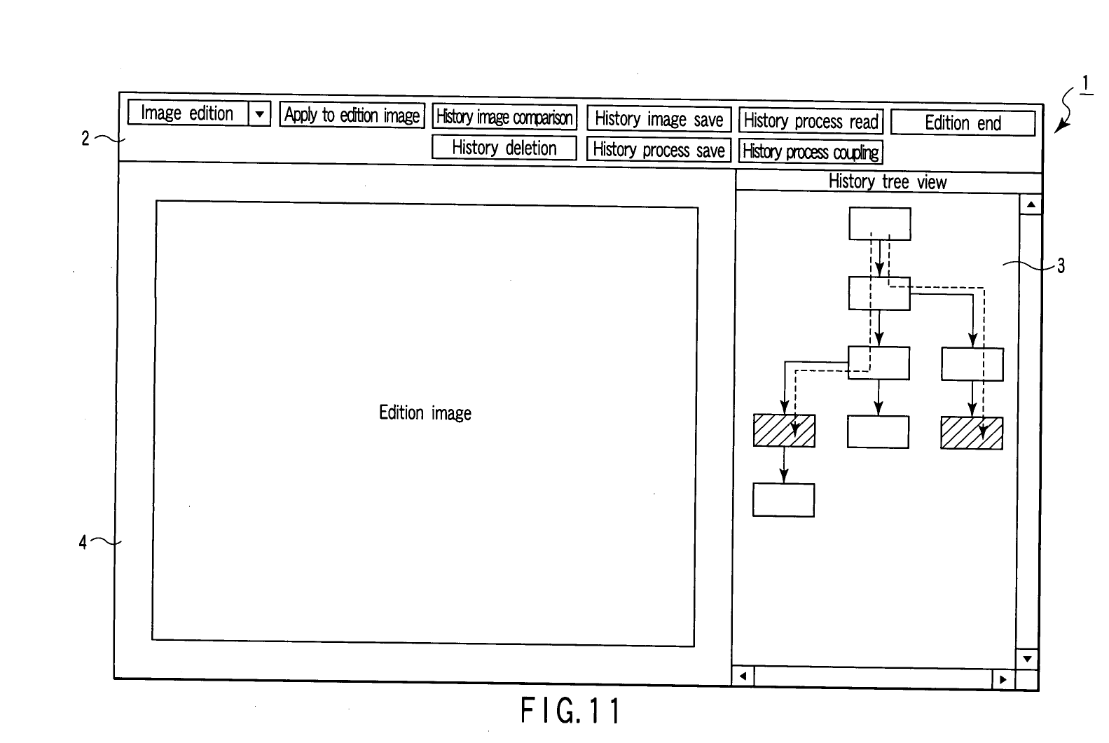

History process save processing for a history image will now be described with reference to FIG. 11.

When a user selects one or more history thumbnail images 5 whose processing process should be saved from history thumbnail images 5 displayed in a history tree, display of the history thumbnail images 5 is changed to a selection state just like the above-described selection processing. Further, an image corresponding to the selected history thumbnail image 5 is displayed in the edition image display portion 4. When the plurality of history thumbnail images 5 are selected, corresponding images are also displayed in parallel.

Then, when the user presses the history process save button 16 is pressed, a route to the selected history thumbnail image 5 is displayed with an original image being determined as a starting point, and a box (not shown) in which a file name under which the image is saved is displayed. When the data is set in this box, a history process executed in this route is saved.

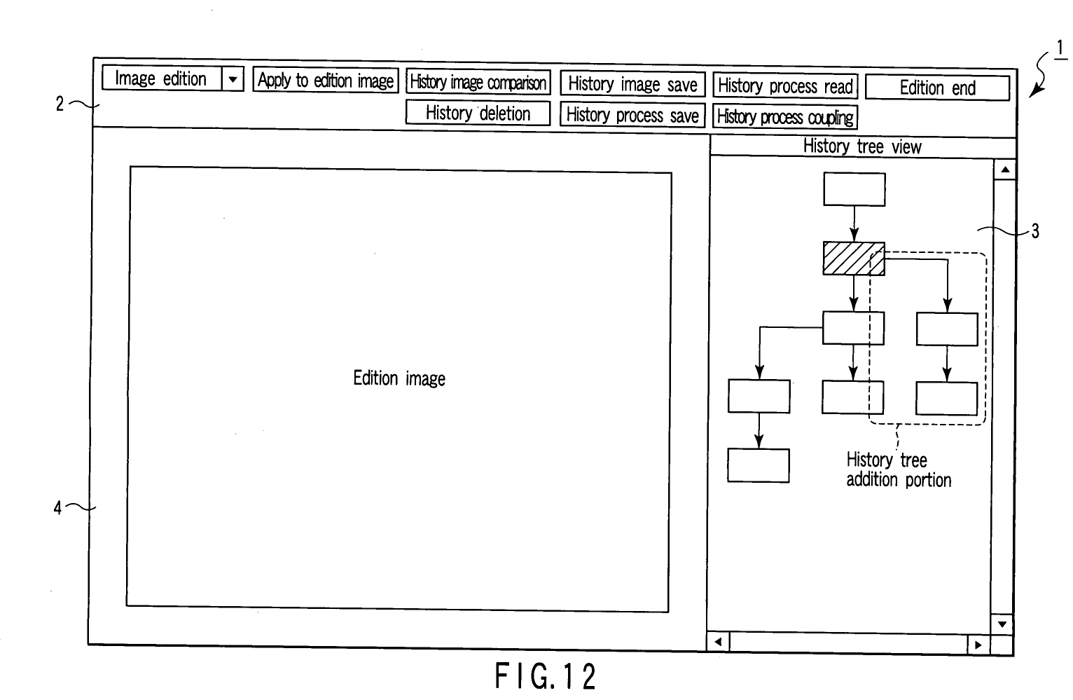

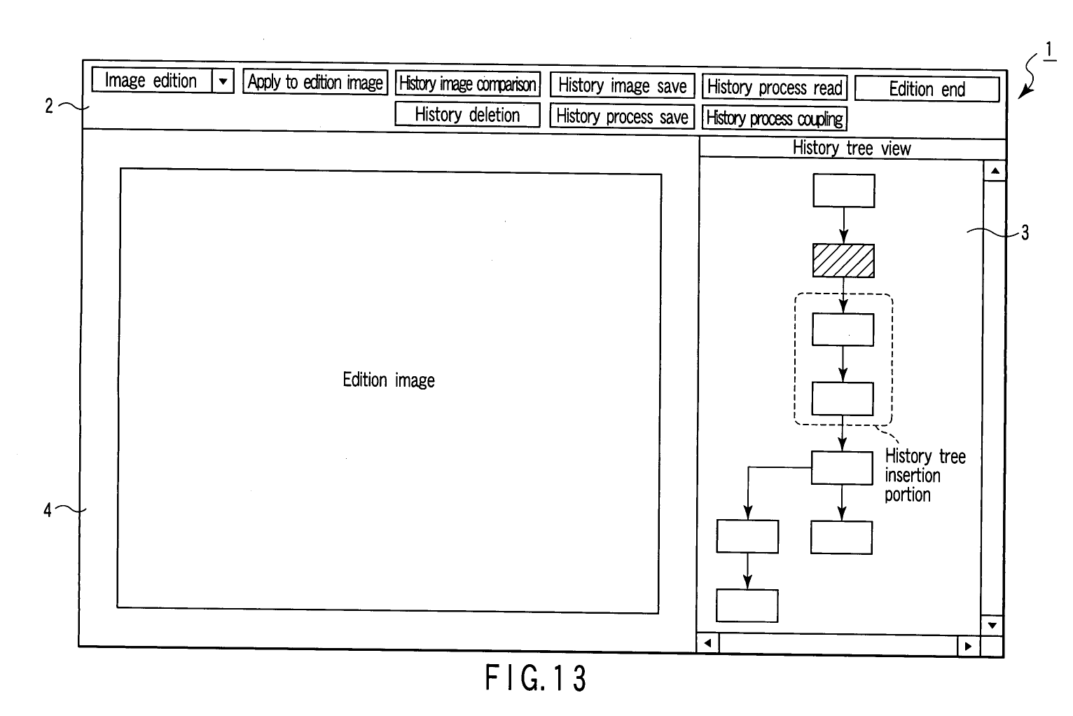

History process read processing will now be described with reference to FIGS. 12 and 13.

When a user selects one history thumbnail image 5 whose history process should be read and which should be a starting point from history thumbnail images 5 displayed in a history tree, display of the history thumbnail image 5 is changed to a selection state just like the above-described selection processing. Moreover, an image corresponding to the selected history thumbnail image 5 is displayed in the edition image display portion 4.

Then, when the user presses the history process read button 17, a screen (not shown) which is used to select a history process stored in the history process save processing and a screen (not shown) which is used to select one of an “addition mode” and an “insertion mode” are displayed. When the data is set in these screens, processing corresponding to the mode is executed.

FIG. 12 is a view illustrating the history process read processing in the addition mode. A read history process is added and displayed as a new tree with the selected history thumbnail image 5 being determined as a starting point. As a result, history thumbnail images 5 displayed in the added tree are images obtained as a result of performing the image processing of the read history process with respect to the image as the starting point.

FIG. 13 is a view illustrating the history process read processing in the insertion mode. The read history process is inserted and displayed in the conventional tree with the selected history thumbnail image 5 being determined as a starting point. As a result, history thumbnail images 5 displayed in the inserted tree are images obtained as a result of performing the image processing of the read history process with respect to the image as the starting point. Additionally, the history thumbnail images 5 displayed in the subsequent tree are images obtained as a result of performing the image processing with the image acquired as a result of this image processing being determined as a new target.

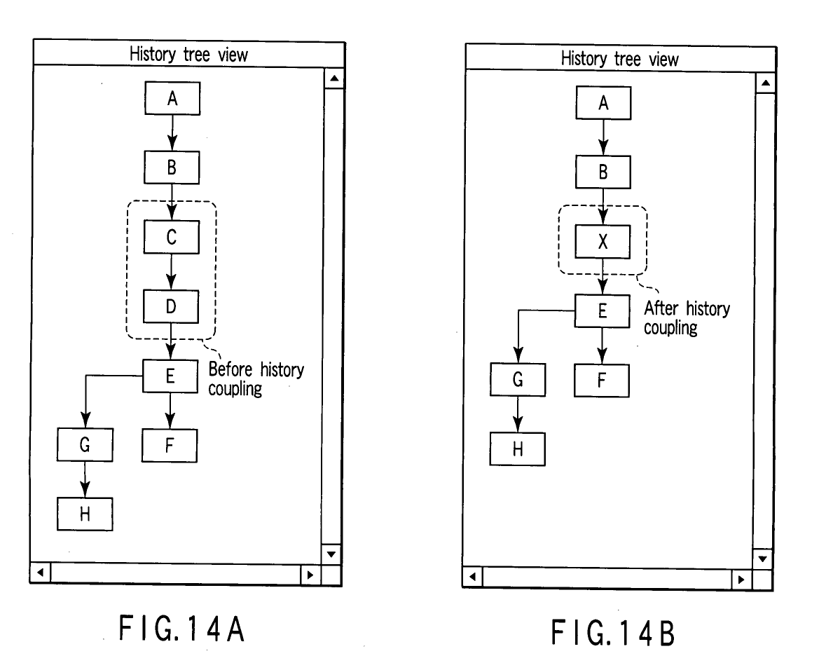

History process coupling processing will now be described with reference to FIG. 14.

In cases where history thumbnail images 5 representing the same type of image processing continuously exist in a current tree, when a user specifies a range of the continuous history thumbnail images 5 and operates the history process coupling button 18, processing contents of the continuous image processing are coupled to be one set of image processing, and the number of history thumbnail becomes one.

FIG. 14A shows a history tree before coupling the history processes, and it is assumed that history processes C and D have the same type of image processing. Then, after operating the history process coupling button 18, as shown in FIG. 14B, the history processes are coupled as X. That is, when the history process C has the brightness of +10 and the history process D has the brightness of +5, the history process X after coupling has the brightness of +15. Further, when the history process C represents 30° rotation in the clockwise direction and the history process D represents 40° rotation in the clockwise direction, the history process after coupling represents 70° rotation in the clockwise direction.

A description will now be given as to a configuration of an information processing apparatus which realizes the image history processing method and its main processing procedure.

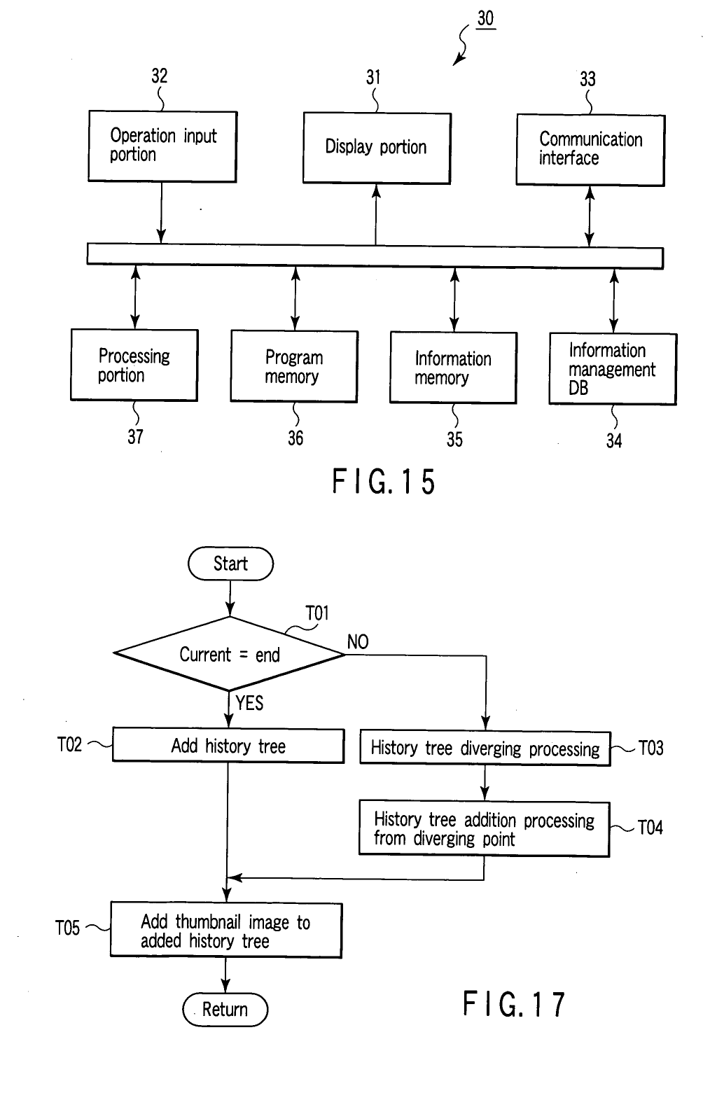

FIG. 15 is a view showing a configuration of an information processing apparatus 30. The image processing apparatus 30 comprises a display portion 31, an operation input portion 32, a communication interface 33, an information management DB 34, an information memory 35, a program memory 36 and a processing portion 37.

The display portion 31 is a CRT or TFT liquid crystal display which displays the image history screen 1. The operation input portion 32 is an input device such as a keyboard or a mouse which receives an operation command input from a user. The communication interface 33 is an interface which transmits/receives information such as an image file with respect to an external device (not shown) such as a digital camera through communication. The information management DB 34 stores an operation history. The information memory 35 is a buffer memory which stores information concerning an operation or information required for the image history processing. The program memory 36 stores a program which controls each function of the information processing apparatus 30. The processing portion 37 controls entire operations of the information processing apparatus 30.

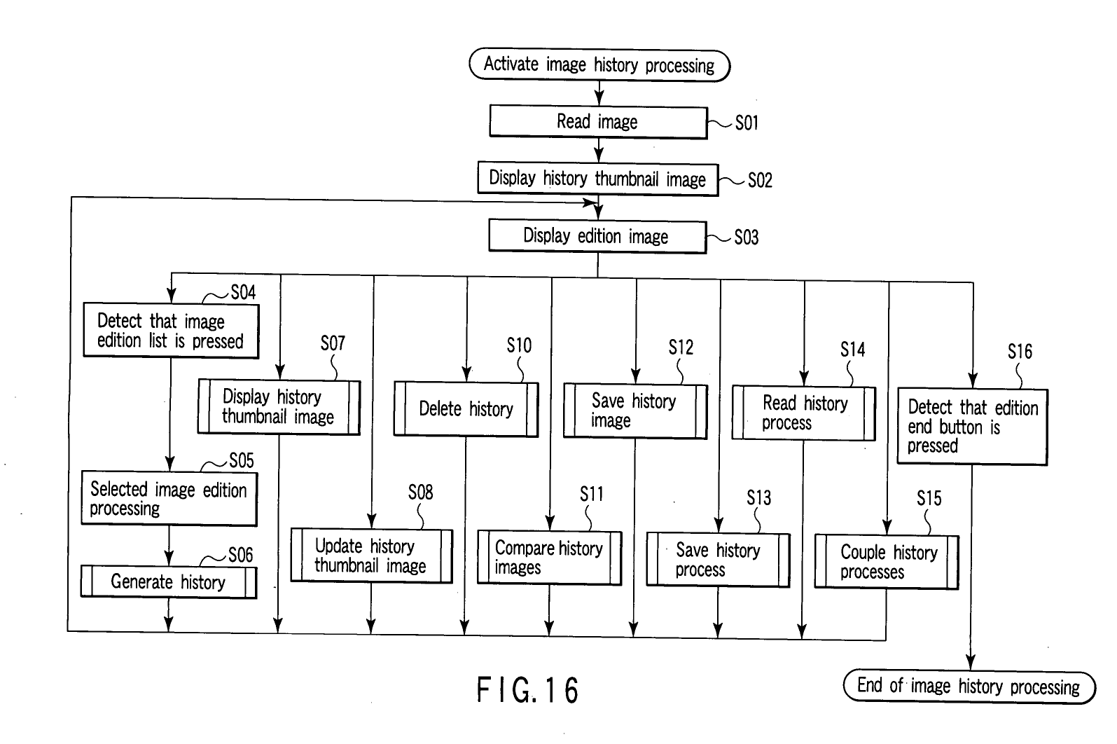

A general procedure of the image history processing will now be described with reference to FIGS. 16 to 25. It is to be noted that the processing described below is processing concerning main functions in image history processing functions. Therefore, even functions which are not described below but described in connection with FIGS. 1 to 14 are included in the image history processing functions.

When a user selects an arbitrary image stored in the information processing apparatus, the processing portion 37 reads this image and looks up in the information management DB 34 in order to extract a history tree including this image so that the history tree and history thumbnail images 5 are displayed in the history tree display area 3 at steps S01 to S02 in FIG. 16.

Then, when the user selects an image to which image processing should be performed from the history thumbnail images 5 in the history tree display area 3, the processing portion 37 displays this image in the edition image display area 4 at a step S03 in FIG. 16.

At steps S04 to S05, when the user selects desired processing from a displayed image edition list by operating the image edition button 11, the processing portion 37 executes the selected image edition processing. Then, history generation processing (FIG. 17) shown at a step S06 is executed.

In case of Yes at a step T01 in FIG. 17, namely, when the currently selected history thumbnail image 5 exists at an end of the history tree, a history tree is added after the state before the processing. In case of No at a step T01, namely, when the currently selected history thumbnail image 5 does not exist at the end of the history tree, the processing portion 37 determines the currently selected history thumbnail image 5 as a diverging point and adds a new history tree from this diverging point at steps T03 to T04.

Furthermore, at a step T05, the processing portion 37 adds and displays thumbnail images of the image to which the image processing is performed to the added history tree, and the control returns.

Again referring to FIG. 16, when a user selects one or more history thumbnail images 5 which should be deleted and presses the history deletion button 14 together with either the “selected history only” mode or the “selected history and subsequent histories” mode, history deletion processing shown at a step S10 corresponding to this mode is executed.

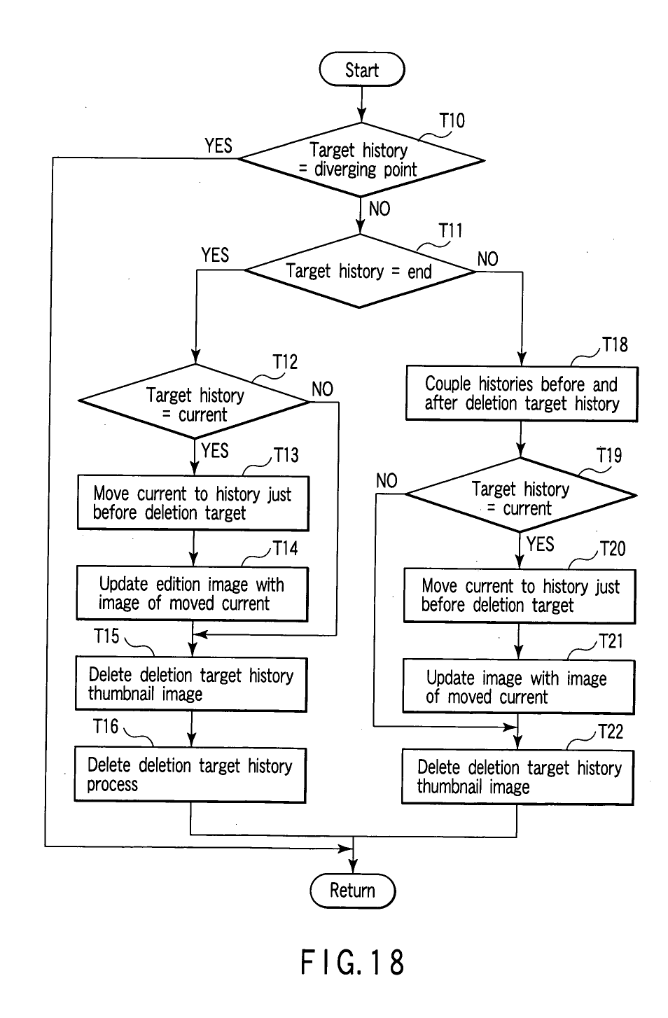

FIG. 18 is a view showing a general procedure of the history deletion processing in the “selected history only” mode.

In case of Yes at a step T10 in FIG. 18, i.e., when a history process as a target of deletion exists at a diverging point, the processing portion 37 does not execute the processing since deletion is impossible, and the control returns. In case of No at the step T10, i.e., when a history process as a target of deletion does not exist at a diverging point, the processing portion 37 checks whether the currently selected history thumbnail image 5 exists at an end of the history tree at a step T11.

In case of Yes at the step T11, i.e., when the currently selected history thumbnail image 5 exists at the end of the history tree, and in case of Yes at a step T12, i.e., when the history thumbnail image 5 as a deletion target is in the current state, the processing portion 37 moves the current state to the history process just before the deletion target, and updates and displays an image corresponding to the current history thumbnail image after movement in the edition image display area 4 at steps T13 to T14.

Then, at steps T15 to T16, the processing portion 37 deletes the thumbnail image 5 as the deletion target, and also deletes the history process of the deletion target and a processing result image, and the control returns. It is to be noted that a new history tree after deletion is recorded in the information management DB 34.

On the other hand, in case of No at the step T11, i.e., when the currently selected history thumbnail image 5 does not exist at the end of the history tree, the processing portion 37 couples the histories before and after the history as the deletion target at a step T18.

In case of Yes at a step T19, i.e., when the history thumbnail image 5 as the deletion target is in the current state, the processing portion 37 moves the current state to a history process just before the deletion target, and updates and displays an image corresponding to the current history thumbnail image 5 after movement in the edition image display area 4 at steps T20 to T21. Then, at a step T22, the processing portion 37 deletes the thumbnail image 5 as the deletion target, and the control returns.

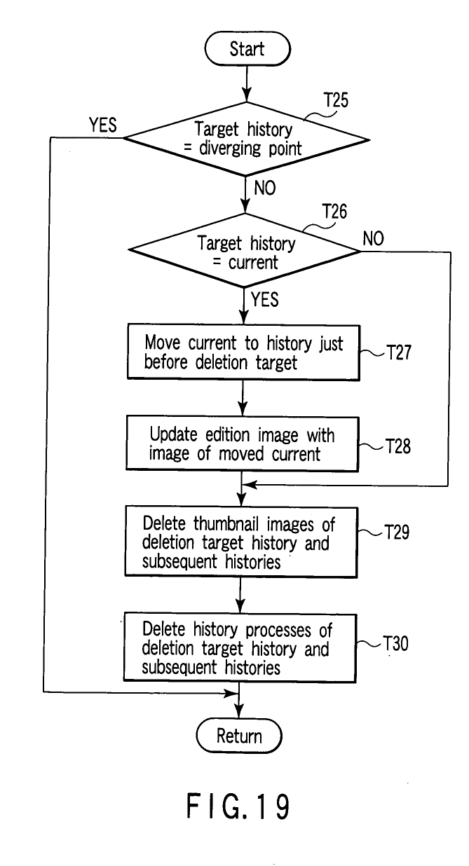

FIG. 19 is a view showing a general procedure of the history deletion processing in the “selected history and subsequent histories” mode.

In case of Yes at a step T25 in FIG. 19, i.e., when a history process as a deletion target exists at a diverging point, the processing portion 37 does not execute the processing since deletion is impossible, and the control returns. In case of No at a step T25, i.e., when the history process as the deletion target does not exist at a diverging point, the processing portion 37 checks whether the history thumbnail image 5 as the deletion target is in the current state at a step T26.

In case of Yes at the step T26, i.e., when the history thumbnail image 5 as the deletion target is in the current state, the processing portion 37 moves the current state to a history just before the deletion target, and updates and displays an image corresponding to the current history thumbnail image 5 after movement in the edition image display area 4 at steps T27 to T28.

Furthermore, at steps T29 to T30, the history thumbnail image 5 as the deletion target and the subsequent history thumbnail images 5 are all deleted, the history process as the deletion target, the subsequent history processes and the processing target images are all deleted, and the control returns.

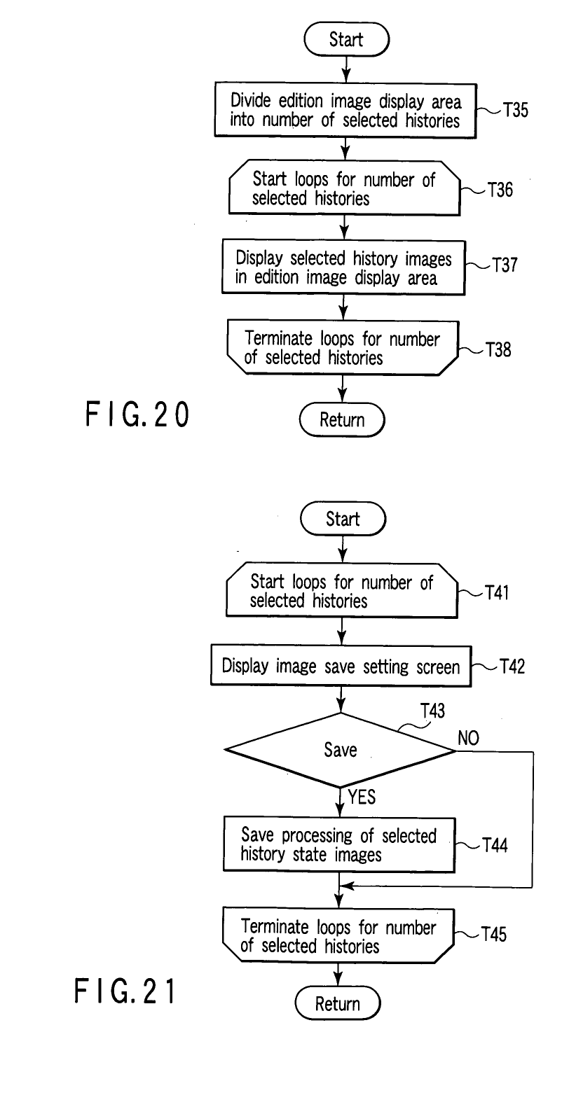

Again referring to FIG. 16, when a user selects a plurality of history thumbnail images 5 which should be displayed for comparison from history thumbnail images 5 displayed in a history tree and presses the history image comparison button 13, history image comparison processing (FIG. 20) shown at a step S11 is executed.

At steps T35 to T38 in FIG. 20, the processing portion 37 divides the edition image display areas 4 into the number of the selected history thumbnail images 5 and displays the respective selected history thumbnail images 5 in the divided areas, and the control returns.

Again referring to FIG. 16, when a use selects a plurality of history thumbnail images 5 which should be saved and presses the history image save button 15, history image save processing (FIG. 21) at a step S12 is executed.

At steps T41 to T45 in FIG. 21, the processing portion 37 displays a box (not shown) in which a folder in which an image is saved, a file name under which an image is saved, an image format in which an image is saved and others are set. Moreover, when the data is set and a save operation is instructed from a user, an image corresponding to the selected history thumbnail image 5 is saved in an actual image size. This processing is executed with respect to all the selected history thumbnail images 5, and the control returns.

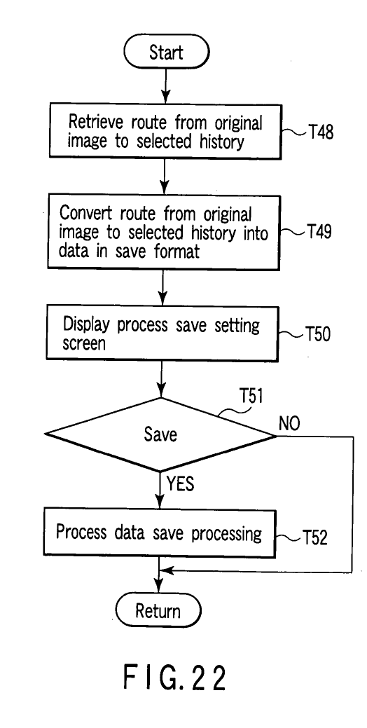

Again referring to FIG. 16, when a user selects one or more history thumbnail images 5 whose process should be saved and presses the history process save button 16, history process save processing (FIG. 22) at a step S13 is executed.

At steps T48 to T50 in FIG. 22, the processing portion 37 retrieves a route to the selected history thumbnail image 5 with an original image being determined as a starting point, and converts this route into data in the save format. Then, the processing portion 37 displays a process save setting screen under which a file name under which the image is saved or the like is set. At steps T51 to T52, when a user sets the data and instructs save, the processing portion 37 saves each history process performed in this route, and the control returns.

Again referring to FIG. 16, when a user selects one history thumbnail image 5 as a starting point from which a history process is read, specifies one of the “addition mode” and the “insertion mode” and presses the history process read button 17, history process read processing at a step S14 is executed with respect to the mode.

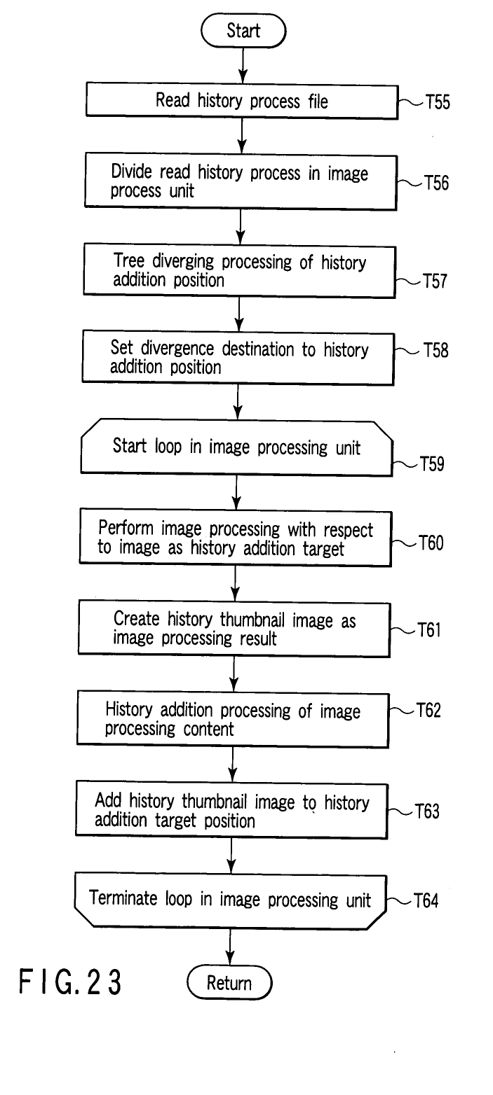

FIG. 23 is a view showing a general procedure of the history process read processing in the addition mode.

At steps T55 to T58, the processing portion 37 reads a history process file and divides history process data which should be processed in units of image processing. Additionally, a position of the history tree of the selected history thumbnail image 5 is set as a new diverging point.

Then, the processing portion 37 repeatedly executes the following processing in units of image processing. At steps T60 to T61, the processing portion 37 executes corresponding image processing with respect to an image to be added, and creates a history thumbnail image 5 as a result of the image processing. Further, at steps T62 to T63, the processing portion 37 sets an image processing content as a history process at this position, and adds and displays the history thumbnail image 5 at a position of the added history tree in the history tree display area 3. The processing portion 37 executes the processing at the steps T60 to T63 in all the image processing units and stores the new history tree created by the addition processing in the information management DB 34, and the control returns.

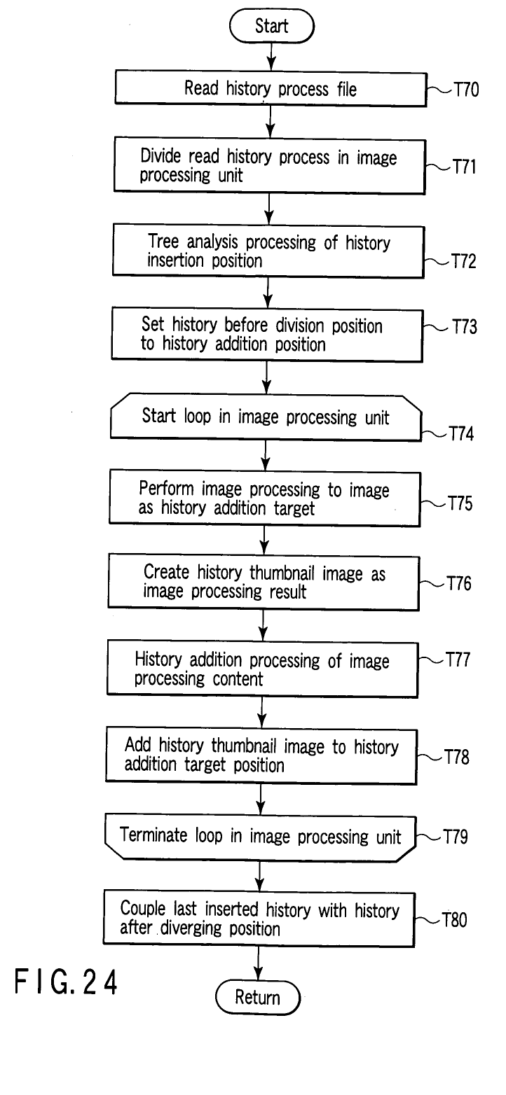

FIG. 24 is a view showing a general procedure of the history process read processing in the insertion mode.

At steps T70 to T73, the processing portion 37 reads a history process file, and divides history process data which should be processed in units of image processing. Then, the processing portion 37 inserts a new history tree concerning the read history process at a position following the history tree of the selected history thumbnail image 5.

Subsequently, the processing portion 37 repeatedly executes the following processing in units of image processing. At steps T75 to T76, the processing portion 37 executes corresponding image processing with respect to an image to be added, and creates a history thumbnail image 5 as a result of the image processing. Further, at steps T77 to T78, the processing portion 37 sets an image processing content as a history process as this position, and adds and displays the history thumbnail image 5 at a position of the added history tree in the history tree display area 3. After executing the processing at the steps T75 to T78 in all the image processing units, the processing portion 37 couples the last inserted history with the history following the diverging point and stores the new history tree created by the coupling processing in the information management DB 34, and the control returns.

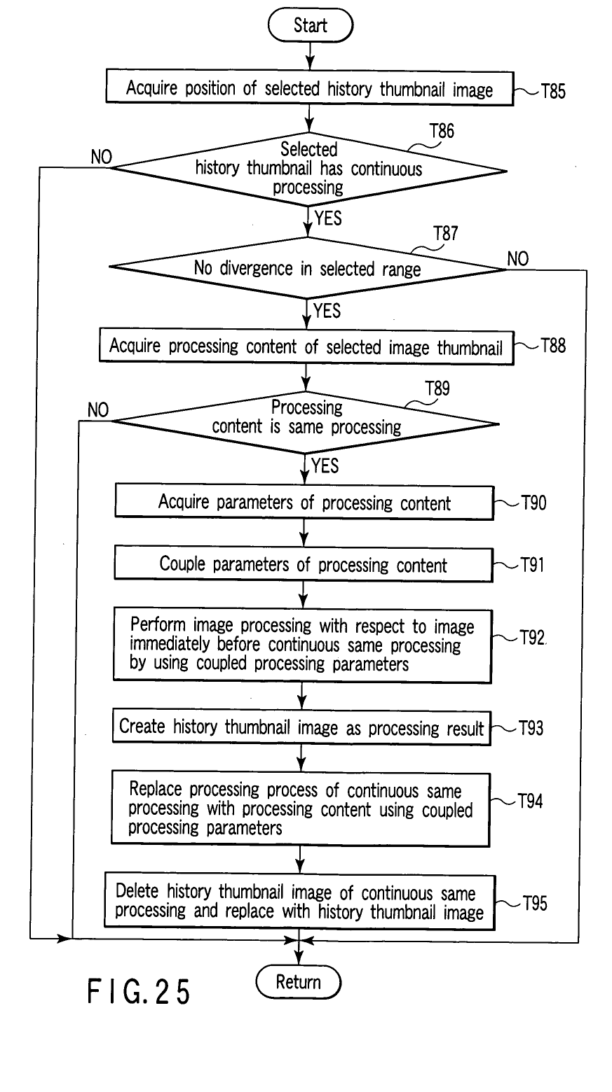

Again referring to FIG. 16, when a user specifies a range of continuous history thumbnail images 5 and operates the history process coupling button 18, history process coupling processing (FIG. 25) at a step S15 is executed.

At steps T85 to T86 in FIG. 25, the processing portion 37 acquires a position of the selected history thumbnail images 5, and checks whether the history processes in this range are continuous processing. In case of No at a step T86, i.e., when these history processes are not the continuous processing, the processing portion 37 terminates the history process coupling processing, and the control returns.

In case of Yes at the step T86, i.e., when the history processes in the range are the continuous processing, the processing portion 37 checks whether a diverging point exists in the selected range and, in case of No at a step T87, i.e., when there is a diverging point, the processing portion 37 terminates the history process coupling processing, and the control returns.

In case of Yes at the step T87, i.e., when there is no diverging point in the selected range, the processing portion 37 checks whether the continuous history processes have the same processing content at a step T89. In case of No at the step T89, i.e., when the continuous history processes do not have the same processing content, the processing portion 37 terminates the history process coupling processing, and the control returns.

In case of Yes at the step T89, i.e., when the continuous history processes have the same processing content, the processing portion 37 fetches and couples parameters of the processing content, and performs image processing based on the coupled processing parameters to an image immediately before the selected range. Then, at steps T93 to T95, the processing portion 37 creates a new history thumbnail image 5 as a result of the image processing, and replaces the history thumbnail images 5 in the range with the new history thumbnail image 5. Furthermore, the processing portion 37 changes the coupled history process into a processing content of the coupled processing parameter, and the control returns.

Again referring to FIG. 16, when a user operates the edition end button 19, the processing portion 37 detects that the edition end button is pressed and terminates the image history processing at a step S16.

It is to be noted that, if a history tree is modified even though a description is not given in each of the above-described processing, information of a new history tree is stored in the information management DB 34.

According to the embodiment mentioned above, which processing is performed to an edition image can be confirmed at one view based on a tree of history thumbnail images 5 displayed in the history tree display area 3.

Moreover, since an image obtained as a result of performing processing in the past or its processing content is held as a history even if the control returns to the previous image state and new processing is executed, it is possible to compare processing result images which have the same processing partway but differ in subsequent processing in a plurality of sets of image processing, thereby readily acquiring an excellent image processing result.

Additionally, since all the image processing contents are held, the image processing processes can be reproduced, and the same image processing process can be easily applied to other images.

It is to be noted that the history thumbnail image 5 may be an icon representing information capable of identifying a history including a thumbnail image.

It is to be noted that each function described in the foregoing embodiment may be constituted by using hardware or it may be realized by reading a program having each function written therein into a computer by using software. Further, each function may be constituted by appropriately selecting one of software and hardware.

Further, each function can be realized by reading a program stored in a non-illustrated storage medium into a computer. Here, a recording type of the recording medium in this embodiment may take any conformation as long as the recording medium can record a program therein and a computer can read the program from this storage medium.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general invention concept as defined by the appended claims and their equivalents.

1. An image processing program executed in an image processing apparatus which comprises: an information memory which stores information including an image; an image processing portion which executes a plurality of sets of processing to an image; and a display having an image display area in which an image is displayed and a history display area in which an image processing history is displayed in the form of a tree of history icons representing image processing, the program causing the image processing apparatus to execute:
an image processing selection step of determining an image displayed in the image display area in accordance with a first history icon selected in the history display area as a processing target image, and selecting image processing which is performed to the processing target image;
an image processing step of executing the image processing selected at the image processing selection step with respect to the processing target image;
an image display step of displaying a processing result image generated as a processing result of the image processing executed at the image processing step instead of the processing target image in the image display area;
a history storage step of storing the processing result image and processing information indicative of a content of the image processing executed at the image processing step in the information memory;
a history icon generation step of generating a second history icon representing the image processing executed at the image processing step;
a history icon display step of setting the second history icon in a selection state successively after the first history icon and adding and displaying the second history icon in the history display area;
a first repeat step of determining the image displayed in the image display area at the image display step as a new processing target image and repeatedly executing the image processing selection step to the history icon display step;
a history icon selection step of selecting a third history icon displayed in the history display area;
a second image display step of displaying a processing result image of image processing represented by the third history icon selected at the history icon selection step instead of the image displayed in the image display area; and
a second repeat step of determining the image displayed in the image display area at the second image display step as a new processing target image and repeatedly executing the image processing selection step to the history icon display step.

2. The image processing program according to claim 1, wherein, when a fourth history icon is displayed successively after the first history icon in the history display area, the history icon display step displays the second history icon alongside of the fourth history icon.

3. The image processing program according to claim 2, wherein the program causes the image processing apparatus to further execute:
an image selection step of selecting a captured image, or an image input from the outside, or an image stored in the information memory;
a third image display step of displaying the image selected at the image selection step in the image display area; and
a processing target image setting step of setting the image displayed at the third image display step as the processing target image.

4. The image processing program according to claim 3, wherein the program causes a computer to further execute:
a second history icon selection step of selecting a plurality of history icons displayed in the history display area; and
a fourth image display step of displaying processing result images corresponding to the respective history icons selected at the second history icon selection step in parallel in the image display area.

5. The image processing program according to claim 3, wherein the program causes the computer to further execute:
a third history icon selection step of selecting at least one history icon from the plurality of history icons displayed in the history display area; and
an image storage step of storing a processing result image corresponding to the history icon selected at the third history icon selection step in the information memory.

6. The image processing program according to claim 3, wherein the program causes the computer to further execute:
a third history icon selection step of selecting at least one history icon from the plurality of history icons displayed in the history display area; and
a process storage step of storing in the information memory processing information of all sets of image processing from image processing represented by a first history icon displayed in the history display area to image processing represented by each history icon selected at the third history icon selection step.

7. The image processing program according to claim 6, wherein the program causes the computer to further execute:
a fourth history icon selection step of selecting one history icon from the plurality of history icons displayed in the history display area;
a process read step of reading processing information of the image processing stored at the process storage step from the information memory;
a third image processing step of sequentially executing each image processing specified by the processing information read at the process read step with respect to a processing result image corresponding to the history icon selected at the fourth history icon selection step;
a second history icon display step of displaying in the history display area a history icon representing each image processing executed at the third image processing step successively after a fifth history icon selected at the fourth history icon selection step; and
a third history storage step of storing in the information memory processing information and a corresponding processing result image of image processing represented by the history icon displayed at the second history icon display step.

8. The image processing program according to claim 7, wherein the program causes the computer to further execute:
a fourth history icon display step of displaying a history icon representing the image processing sequentially executed at the third image processing step between the fifth history icon and a sixth history icon when the fifth history icon selected at the fourth history icon selection step is followed by the sixth history icon;
a first reprocessing step of determining a processing result image of the image processing at the third image processing step as a processing target image, and sequentially executing image processing represented by the sixth history icon and all subsequent icons; and
a second image storage step of storing in the information memory processing result images corresponding to the sixth history icons and all the subsequent history icons.

9. The image processing program according to claim 3, wherein the program causes the computer to further execute:
a fifth history icon selection step of selecting a history icon displayed in the history display area;
a deletion instruction step of instructing deletion; and
a history icon deletion step of deleting the history icon selected at the fifth history selection step from the history display area in accordance with the instruction at the deletion instruction step.

10. The image processing program according to claim 9, wherein the program causes the computer to further execute:
a second reprocessing step of determining a processing result image corresponding to a history icon immediately before the history icon deleted at the history icon deletion step as a processing target image, and sequentially executing each image processing represented by each of all history icons following the history icon deleted at the history icon deletion step; and
a history update step of updating a processing result image and processing information which are stored in the information memory and correspond to each history icon following the deleted history icon.

11. The image processing program according to claim 9, wherein the history icon deletion step deletes the history icon selected at the fifth history icon selection step and all subsequent history icons from the history display area.

12. The image processing program according to claim 9, wherein, when the history icon selected at the fifth history icon selection step is followed by a plurality of history icons in parallel, the history icon deletion step is not executed even if there is the deletion instruction at the deletion instruction step.

13. The image processing program according to claim 3, wherein the program causes the computer to further execute:
an image processing integration step of integrating continuous sets of image processing which are of the same type into one set of image processing when the sets of image processing represented by continuous history icons displayed in the history display area are of the same type;
a fifth history icon display step of deleting a history icon corresponding to the image processing as an integration target before the integration, and displaying one history icon representing the image processing integrated at the image processing integration step in place of the deleted history icon; and
a fourth history storage step of storing in the information memory a processing result image and processing information of the image processing integrated at the image processing integration step.

14. An image processing method executed in an image processing apparatus which comprises: an information memory which stores information including an image; an image processing portion which executes a plurality of sets of processing with respect to an image; and a display having an image display area in which an image is displayed and a history display area in which an image processing history is displayed in the form of a tree of history icons representing image processing, the method comprising:
(A1) determining an image displayed in the image display area in accordance with a first history icon selected in the history display area as a processing target image, and selecting image processing which is performed with respect to the processing target image;
(A2) executing the image processing selected at (A1) with respect to the processing target image;
(A3) displaying in the image display area a processing result image generated as a processing result of the image processing executed at (A2) in place of the processing target image;
(A4) storing in the information memory the processing result image and processing information indicative of a content of the image processing executed at (A2);
(A5) generating a second history icon representing the image processing executed at (A2);
(A6) adding and displaying the second history icon successively after the first history icon in the history display area;
(A7) determining the image displayed in the image display area at (A3) as a new processing target image, and repeatedly executing (A1) to (A6);
(A8) selecting a third history icon displayed in the history display area;
(A9) displaying a processing result image of image processing represented by the third history icon selected at (A8) in place of the image displayed in the image display area; and
(A10) determining the image displayed in the image display area at (A9) as a new processing target image, and repeatedly executing (A1) to (A6).

15. The image processing method according to claim 14, wherein, in (A6), when a fourth history icon following the first history icon is displayed in the history display area, the second history icon is displayed alongside of the fourth history icon.

16. The image processing method according to claim 15, further comprising:
(B1) selecting a captured image, or an image input from the outside, or an image stored in the information memory;
(B2) displaying the image selected at (B1) in the image display area; and
(B3) setting the image displayed at (B2) as the processing target image.

17. The image processing method according to claim 16, further comprising:
(C1) selecting a plurality of history icons displayed in the history display area; and
(C2) displaying in the image display area processing result images corresponding to the respective history icons selected at (C1) in parallel.

18. The image processing method according to claim 16, further comprising:
(D1) selecting at least one history icon from the plurality of history icons displayed in the history display area; and
(D2) storing in the information memory a processing result image corresponding to the history icon selected at (D1).

19. The image processing method according to claim 16, further comprising:
(E1) selecting at least one history icon from the plurality of history icons displayed in the history display area; and
(E2) storing in the information memory processing information of all sets of image processing from image processing represented by a first history icon displayed in the history display area to image processing represented by each history icon selected at (E1).

20. The image processing method according to claim 19, further comprising:
(F1) selecting one history icon from the plurality of history icons displayed in the history display area;
(F2) reading processing information of the image processing stored at (E2) from the information memory;
(F3) sequentially executing each image processing specified by the processing information read at (F2) with respect to a processing result image corresponding to the history icon selected at (F1);
(F4) displaying in the history display area a history icon representing each image processing executed at (F3) successively after a fifth history icon selected at (F1); and
(F5) storing in the information memory processing information and a corresponding result image of image processing represented by the history icon displayed at (F4).

21. The image processing method according to claim 20, further comprising:
(G1) displaying a history icon representing the image processing sequentially executed at (F3) between the fifth history icon and a sixth history icon when the fifth history icon selected at (F1) is followed by the sixth history icon;
(G2) determining a processing result image of the image processing at (F3) as a processing target image, and sequentially executing image processing represented by the sixth history icon and all subsequent history icons; and
(G3) storing in the information memory processing result images corresponding to the sixth history icon and all the subsequent history icons.

22. The image processing method according to claim 16, further comprising:
(H1) selecting a history icon displayed in the history display area;
(H2) instructing deletion; and
(H3) deleting the history icon selected at (H1) from the history display area in accordance with the instruction at (H2).

23. The image processing method according to claim 22, further comprising:
(I1) determining a processing result image corresponding to a history icon immediately before the history icon deleted at (H3) as a processing target image, and sequentially executing each image processing represented by all history icons following the history icon deleted at (H3); and
(I2) updating a processing result image and processing information which are stored in the information memory and correspond to each history icon following the deleted history icon.

24. The image processing method according to claim 22, further comprising:
(J1) deleting the history icon selected at (H1) and all subsequent history icons from the history display area at (H3).

25. The image processing method according to claim 22, further comprising:
(K1) not executing (H3) even if there is the instruction of deletion at (H2) when the history icon selected at (H1) is followed by a plurality of history icons in parallel.

26. The image processing method according to claim 16, further comprising:
(L1) integrating continuous sets of image processing which are of the same type into one set of image processing when the sets of image processing represented by continuous history icons displayed in the history display area are of the same type;
(L2) deleting a history icon corresponding to the image processing as an integration target before the integration;
(L3) displaying one history icon representing the image processing integrated at (L1) in place of the deleted history icon; and
(L4) storing a processing result image and processing information of the image processing integrated at (L1) in the information memory.

27. An image processing apparatus comprising:
an information memory which stores information including an image;
an image processing portion which executes a plurality of sets of processing with respect to an image;
a display having an image display area in which an image is displayed and a history display area in which an image processing history is displayed in the form of a tree of history icons;
an image processing selection portion which determines an image displayed in the image display area in accordance with a first history icon selected in the history display area as a processing target image, and selects image processing which is performed with respect to the processing target image;
an image processing portion which executes the image processing selected by the image processing selection portion with respect to the processing target image;
an image display portion which displays in the image display area a processing result image generated as a processing result of the image processing executed by the image processing portion in place of the processing target image;
a history storage portion which stores the processing result image and processing information indicative of a content of the image processing executed by the image processing portion in the information memory;
a history icon generation portion which generates a second history icon representing the image processing executed by the image processing portion;
a history icon display portion which sets the second history icon in a selection state successively after the first history icon, and adds and displays the second history icon in the history display area;
a first repeat portion which determines the image displayed in the image display area by the image display portion as a new processing target, and repeatedly executes operations of the image processing selection portion to the history icon display portion;
a history icon selection portion which selects a third history icon displayed in the history display area;
a second image display portion which displays a processing result image of image processing represented by the third history icon selected by the history icon selection portion in place of an image displayed in the image display area; and
a second repeat portion which determines the image displayed in the image display area by the second image display portion as a new processing target, and repeatedly executes operations of the image processing selection portion to the history icon display portion.

28. The image processing apparatus according to claim 27, wherein, when a fourth history icon following the first history icon is displayed in the history display area, the history icon display portion displays the second history icon alongside of the fourth history icon.

29. The image processing apparatus according to claim 28, further comprising:
an image selection portion which selects a captured image, or an image input from the outside, or an image stored in the information memory;
a third image display portion which displays an image selected by the image selection portion in the image display area; and
a processing target image setting portion which sets an image displayed by the third image display portion as the processing target image.

30. The image processing apparatus according to claim 29, further comprising:
a second history icon selection portion which selects a plurality of history icons displayed in the history display area; and
a fourth image display portion which displays processing result images corresponding to the respective history icons selected by the second history icon selection portion in parallel in the image display area.

31. The image processing apparatus according to claim 29, further comprising:
a third history icon selection portion which selects at least one history icon from the plurality of history icons displayed in the history display area; and
an image storage portion which stores a processing result image corresponding to the history icon selected by the third history icon selection portion.

32. The image processing apparatus according to claim 29, further comprising:
a third history icon selection portion which selects at least one history icon from the plurality of history icons displayed in the history display area; and
a process storage portion which stores in the information memory processing information of all sets of image processing from image processing represented by a first history icon displayed in the history display area to image processing represented by each history icon selected by the third history icon selection portion.

33. The image processing apparatus according to claim 29, further comprising:
a fourth history icon selection portion which selects one history icon from the plurality of history icons displayed in the history display area;
a process read portion which reads processing information of the image processing stored by the process storage portion from the information memory;
a third image processing portion which sequentially executes each image processing specified by the processing information read by the process read portion with respect to a processing result image corresponding to the history icon selected by the fourth history icon selection portion;
a second history icon display portion which displays in the history display area a history icon representing each image processing executed by the third image processing portion successively after a fifth history icon selected by the fourth history icon selection portion; and
a third history storage portion which stores processing information and a corresponding processing result image of image processing represented by the history icon displayed by the second history icon display portion in the information memory.

34. The image processing apparatus according to claim 33, further comprising:
a fourth history icon display portion which displays a history icon representing the image processing sequentially executed by the third image processing portion between the fifth history icon and a sixth history icon when the sixth history icon follows the fifth history icon selected by the fourth history icon selection portion;
a first reprocessing portion which determines a processing result image of the image processing by the third image processing portion as a processing target image, and sequentially executes image processing represented by the sixth history icon and all subsequent history icons; and
a second image storage portion which stores processing result images corresponding to the sixth history icon and all the subsequent history icons in the information memory.

35. The image processing apparatus according to claim 29, further comprising:
a fifth history icon selection portion which selects a history icon displayed in the history display area;
a deletion instruction portion which instructs deletion; and
a history icon deletion portion which deletes a history icon selected by the fifth history selection portion from the history display area in accordance with the instruction by the deletion instruction portion.

36. The image processing apparatus according to claim 35, further comprising:
a second reprocessing portion which determines a processing result image corresponding to a history icon immediately before the history icon deleted by the history icon deletion portion as a processing target image, and sequentially executes each image processing represented by all history icons following the history icon deleted by the history icon deletion portion; and
a history update portion which updates a processing result image and processing information which are stored in the information memory and correspond to each history icon following the deleted history icon.

37. The image processing apparatus according to claim 35, wherein the history icon deletion portion deletes the history icon selected by the fifth history icon selection portion and subsequent all history icons from the history display area.

38. The image processing apparatus according to claim 35, wherein, when the history icon selected by the fifth history icon is followed by a plurality of history icons in parallel, an operation of the history icon deletion portion is not executed even if there is the instruction of deletion by the deletion instruction portion.

39. The image processing apparatus according to claim 29, further comprising:
an image processing integration portion which integrates continuous sets of image processing which are of the same type into one set of image processing when the sets of image processing represented by continuous history icons displayed in the history display area are of the same type;
a fifth history icon display portion which deletes a history icon corresponding to the image processing as an integration target before the integration, and displays one history icon representing the image processing integrated by the image processing integration portion in place of the deleted history icon; and
a fourth history storage portion which stores a processing result image and processing information of the image processing integrated by the image processing integration portion in the information memory.

40. A storage medium having a program recorded therein, the program being executed in an image processing apparatus comprising: an information memory which stores information including an image; an image processing portion which executes a plurality of sets of processing with respect to an image; and a display having an image display area in which an image is displayed and a history display area in which an image processing history is displayed in the form of a tree of history icons representing image processing,
the storage medium having the program recorded therein, the program causing a computer to execute:
an image processing selection step of determining an image displayed in the image display area in accordance with a first history icon selected in the history display area as a processing target image, and selecting image processing which is performed with respect to the processing target image;
an image processing step of executing the image processing selected at the image processing selection step with respect to the processing target image;
an image display step of displaying in the image display area a processing result image generated as a processing result of the image processing executed at the image processing step in place of the processing target image;
a history storage step of storing in the information memory the processing result image and processing information indicative of a content of the image processing executed at the image processing step;
a history icon generation step of generating a second history icon representing the image processing executed at the image processing step;
a history icon display step of setting the second history icon in a selection state successively after the first history icon, and adding and displaying the second history icon in the history display area;
a first repeat step of determining the image displayed in the image display area at the image display step as a new processing target image and repeatedly executing the image processing selection step to the history icon display step;
a history icon selection step of selecting a third history icon displayed in the history display area;
a second image display step of displaying a processing result image of image processing represented by the third history icon selected at the history icon selection step in place of an image displayed in the image display area; and
a second repeat step of determining the image displayed in the image display area at the second image display step as a new processing target image and repeatedly executing the image processing selection step to the history icon display step.

41. The storage medium according to claim 40, wherein, when a fourth history icon follows the first history icon and is displayed in the history display area, the history icon display step displays the second history icon alongside of the fourth history icon.

42. The storage medium according to claim 41, wherein the storage medium has the program recorded therein, the program causing the computer to execute:
an image selection step of selecting a captured image, or an image input from the outside, or an image stored in the information memory;
a third image display step of displaying the image selected at the image selection step in the image display area; and
a processing target image setting step of setting the image displayed at the third image display step as the processing target image.

43. The storage medium according to claim 42, wherein the storage medium has the program recorded therein, the program causing the computer to execute:
a second history icon selection step of selecting a plurality of history icons displayed in the history display area; and
a fourth image display step of displaying processing result images corresponding to the respective history icons selected at the second history icon selection step in parallel in the image display area.

44. The storage medium according to claim 42, wherein the storage medium has the program recorded therein, the program causing the computer to execute:
a third history icon selection step of selecting at least one history icon from the plurality of history icons displayed in the history display area; and
an image storage step of storing a processing result image corresponding to the history icon selected at the third history icon selection step in the information memory.

45. The storage medium according to claim 42, wherein the storage medium has the program recorded therein, the program causing the computer to execute:
a third history icon selection step of selecting at least one history icon from the plurality of history icons displayed in the history display area; and
a process storage step of storing in the information memory processing information of all sets of image processing from image processing represented by a first history icon displayed in the history display area to image processing represented by each history icon selected at the third history icon selection step.

46. The storage medium according to claim 45, wherein the storage medium has the program recorded therein, the program causing the computer to execute:
a fourth history icon selection step of selecting one history icon from the plurality of history icons displayed in the history display area;
a process read step of reading processing information of the image processing stored at the process storage step from the information memory;
a third image processing step of sequentially executing each image processing specified by the processing information read at the process read step with respect a processing result image corresponding to the history icon selected at the fourth history icon selection step;
a second history icon display step of displaying in the history display area a history icon representing each image processing executed at the third image processing step successively after a fifth history icon selected at the fourth history icon selection step; and
a third history storage step of storing in the information memory processing information and a corresponding processing result image of image processing represented by the history icon displayed at the second history icon display step.

47. The storage medium according to claim 46, wherein the storage medium has the program recorded therein, the program causing the computer to execute:
a fourth history icon display step of displaying a history icon representing the image processing sequentially executed at the third image processing step between the fifth history icon and a sixth history icon when the sixth history icon follows the fifth history icon selected at the fourth history icon selection step;
a first reprocessing step of determining a processing result image of the image processing at the third image processing step as a processing target image, and sequentially executing image processing represented by the sixth history icon and all subsequent history icons; and
a second image storage step of storing processing result images corresponding to the sixth history icon and all the subsequent history icons in the information memory.

48. The storage medium according to claim 42, wherein the storage medium has the program recorded therein, the program causing the computer to execute:
a fifth history icon selection step of selecting a history icon displayed in the history display area;
a deletion instruction step of instructing deletion; and
a history icon deletion step of deleting the history icon selected at the fifth history selection step from the history display area in accordance with the instruction at the deletion instruction step.

49. The storage medium according to claim 48, wherein the storage medium has the program recorded therein, the program causing the computer to execute:
a second reprocessing step of determining a processing result image corresponding to a history icon immediately before the history icon deleted at the history icon deletion step as a processing target image, and sequentially executing each image processing represented by all history icons following the history icon deleted at the history icon deletion step; and
a history update step of updating a processing result image and processing information which are stored in the information memory and correspond to each history icon following the deleted history icon.

50. The storage medium according to claim 48, wherein the history icon deletion step deletes the history icon selected at the fifth history icon selection step and all subsequent history icons from the history display area.

51. The storage medium according to claim 48, wherein, when the history icon selected at the fifth history icon is followed by a plurality of history icons in parallel, the history icon deletion step is not executed even if there is the deletion instruction at the deletion instruction step.

52. The storage medium according to claim 42, wherein the storage medium has the program recorded therein, the program causing the computer to execute:
an image processing integration step of integrating continuous sets of image processing which are of the same type into one set of image processing when the sets of image processing represented by continuous history icons displayed in the history display area are of the same type;
a fifth history icon display step of deleting a history icon corresponding to the image processing as an integration target before the integration, and displaying one history icon representing the image processing integrated at the image processing integration step in place of the deleted history icon; and
a fourth history storage step of storing a processing result image and processing information of the image processing integrated at the image processing integration step in the information memory.
